(19) United States
(12) Patent Application Publication
(10) Pub. No.: US 2013/0045672 A1
(43) Pub. Date: Feb. 21, 2013

(54) Media Radio with User Selectable Content

(71) Applicant: John Sanders, Cordova, TN (US)

(72) Inventor: John Sanders, Cordova, TN (US)

(21) Appl. No.: 13/586,549

(22) Filed: Aug. 15, 2012

Related U.S. Application Data
(60) Provisional application No. 61/523,585, filed on Aug. 15, 2011.

(51) Int. Cl. H04H 20/71

(52) U.S. Cl. 455/3.01

(57) ABSTRACT

A media radio system with user selectable content is provided, comprising a data storage system for storing a plurality of content files, each of the content files being categorized based on select criteria, and wherein each content file contains content information associated with one of a plurality of interest areas; a processing device operatively coupled to the data storage system for processing requests for the content files and the content information; a user interface operatively coupled to the processing device for communicating the requests for the content files and the content information, and for communicating the content files and content information to a system user; an access control system operative with the processing device for enabling access to the stored content file by an authorized system user; and a system for enabling the system user to select predetermined content files for broadcasting over radio frequencies to subscribing customers.

### CROSS-REFERENCE TO RELATED APPLICATIONS

This nonprovisional patent application claims priority under 35 U.S.C. §119 to U.S. Provisional Application Ser. No. 61/523,585, filed on Aug. 15, 2011.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

INCORPORATION-BY-REFERENCE OF MATERIAL SUBMITTED ON COMPACT DISC

Not applicable.

### BACKGROUND OF THE INVENTION

1. Field of the Invention

The present invention relates to methods and systems for creating media radio with user selectable content, and broadcasting the content over a global network to subscribing users.

2. Description of Related Art

Traditionally most music and talk broadcasting is still done via radio airwaves governed by the FCC. An entity can either own an individual station or a network of multiple stations. These stations could either have “live” DJ's and broadcast their content or the network could broadcast one format simultaneously covering many different areas or cities of the country with the exact same content.

With the advancement of technology another option is to stream that specific station online or with the use of a mobile web application. This aforementioned method is typically how most radio is broadcast. Another option is to for an individual user to create their own playlist and stream their content over the Internet. Unless that user can afford to hire DJ's, news reporters, and the like, this amounts to streaming individual material.

This particular process has remained archaic for a couple of reasons. It's always been done this way. This was the preferred method prior to the internet and technology boom. No one has come up with a “better” system. The following are limitations and problems to both of these methods. Currently, a particular network or station is limited in the various ways: (1) the number of songs it can play in a 24 hour period; (2) the number of commercials it can play in a 24 hour period; (3) the particular format(style) is limited to a certain artists/speakers; (4) the number of advertisers one can have during a 24 hour period; (5) the limited number of promotions/events during a given period; and (6) the limited communication on a local level when you are broadcasting on a network.

All of these factors create negative vices like “pay-o-la”, and creates a “one size fits all” approach. This in turns limits the free market ability to allow the best art and creativity to rise to the top. This also limits the consumer from really ever discovering and enjoying the best in a particular category/industry. All of these factors stiffen growth in an already declining music industry. So, currently only the traditional radio station and the individual (which is more for fun than practical) have been given an option on the use of communicating with customers.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

The new method is a concept that allows any user (an individual, group, church, business or any other organization) the ability to have the benefits of the “traditional” model in having professional DJ's and national news as well as encompass the individual's ability to choose personally preferred choices without the cost that running a traditional radio station would encompass.

The new system would allow an organization to pay for the service and choose their programming via morning, afternoon, and evening shows in each category of music in every genre. All their news shows, talk shows, etc., would all be available for them to choose. Therefore, the user does not have to create his own content or produce shows, but could choose individual shows to stream via a service. In addition, the user would be able to specifically choose certain aspects—individual content, songs, commercials, advertisements, etc., thus giving them the ability to compete with the conventional radio stations for a fraction of the traditional cost.

A member organization, such as a church, could use the service in accordance with the present invention like a social media service. This service is another modern way for business and churches to connect with their members on a different level that has not before been available. Thus the new system would give churches or any organization the ability to create their own radio/medial station in about 15 minutes. The church would pick its shows programming on a national level, then be able to insert their individual picks from songs, to speaking, announcements all the way down to the most individual level. For example, a church may pick their morning show, their afternoon show, and their evening show, while their music minister also picks an hour of optional programming and inserts his worship bands CD to their station playlist, or uses the system's default setting. Thus, this selection process reflects his church's personal preferences. Next the pastor adds a 30-second encouraging message to be played at various times through the week all specifically geared to the church members. This could be specifically a follow up to his Sunday message. Lastly, they could advertise the entire calendar of events for the church from everything from summer camps, specific programs, or other specific local announcements—including notices regarding individual church members. This would all be for no additional cost. Not only has this not been done before, the ability for this to be done has not been available before. Hence, allowing the same high quality programming you hear on the radio, but allowing for one's own individual or member group preferences again, for a nominal cost. All of this would be either streamed via the internet or steamed via a mobile web application.

This will give more artists a place to play. It will increase the amount of radio/airplay, and allow more affordable advertising. It will allow many more promotions, and will give way to many more various types of formats, thus increase format sizes. It will also virtually eliminate pay-o-la schemes. It will also provide another option to raise support for the member organization, which could eliminate share-a-thons, etc., and frequent requests for financial support. It would also eliminate missed opportunities because lack of space/time “on air”.

Ultimately, this would change the face of traditional radio. Another example would be a company, such as Wendy's or similar restaurant, which could subscribe to this new system and pick the message and radio content for all their stores, but also have the ability to insert their own commercials, announcements, contests, etc., all for a fraction of conventional costs.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A media radio system with user selectable content, comprising:
(a) a data storage system for storing a plurality of content files, each of the content files being categorized based on select criteria, and wherein each content file contains content information associated with one of a plurality of interest areas;
(b) a processing device operatively coupled to the data storage system for processing requests for the content files and the content information;
(c) a user interface operatively coupled to the processing device for communicating the requests for the content files and the content information, and for communicating the content files and content information to a system user;
(d) an access control system operative with the processing device for enabling access to the stored content file by an authorized system user; and
(e) means for enabling the system user to select predetermined content files for broadcasting over radio frequencies to subscribing customers.
